(19) United States
(12) Patent Application Publication
(10) Pub. No.: US 2026/0316085 A1
(43) Pub. Date: Oct. 15, 2026

(54) ROLL CRUSHER WITH ADJUSTABLE CRUSHING GAP

(71) Applicant: FLSmidth A/S, Valby (DK)

(72) Inventors: Piotr Szczelina, Beckum (DE); Tobias Koch, Bad Sassendorf (DE); Raul Eduardo Ellermann, Gutersloh (DE)

(21) Appl. No.: 19/116,515

(22) PCT Filed: Sep. 27, 2023
(86) PCT No.: PCT/IB2023/059592

§ 371 Date: Mar. 28, 2025

(30) Foreign Application Priority Data
Sep. 29, 2022 (DE) 10 2022 125 159.4
Sep. 29, 2022 (LU) LU502855

(51) Int. Cl. B02C 13/09; B02C 13/26

(52) U.S. Cl. CPC B02C 13/095; B02C 13/26; B02C 2013/29

(57) ABSTRACT

The invention relates to a roll crusher (1) with a machine frame (2), with a rotatable roll (4), with a rocker (8) mounted on a rocker axle (6) on the machine frame (2), with a crushing chamber (9) between roll (4) and rocker (8), wherein an adjustable crushing gap (BS) between roll (4) and
rocker (8) is formed at a lower end of the crushing chamber. The roll (4) is loosely mounted on the machine frame (2). The roll crusher (1) has a roll adjustment device (30) for adjusting the roll (4) perpendicular to its axis of rotation (5) in the direction of the rocker (8) for adjusting the crushing gap (BS). The invention also relates to a method.

The invention relates to a roll crusher with a machine frame, with a rotatable roll, with a rocker mounted on a rocker axle on the machine frame, with a crushing chamber between roll and rocker, wherein an adjustable crushing gap between roll and rocker is formed at a lower end of the crushing chamber. The invention also relates to a method for operating a roll crusher. Such a roll crusher can be configured in particular as an eccentric roll crusher or as a roll crusher with a directly driven roll.

Eccentric roll crushers, which are also known as “Rotex crushers”, are known, for example, from the magazine “Aufbereitungs-Technik, Zeitschrift für die Aufbereitung fester Rohstoffe”, Volume 5 (1964), Issue 5, pages 242 to 247 and “Aufbereitungs-Technik, Zeitschrift für die Aufbereitung fester Rohstoffe”, Volume 6 (1966), Issue 3, pages 166 to 174. In the known configurations of eccentric roll crushers, the rocker is suspended obliquely above the roll and can be pivoted in order to be able to adjust both the entry gap and the exit gap (also called the crushing gap). During operation of the roll crusher, however, the rocker is fixed in its position in order to be able to comminute the material to be crushed, in particular rock. In order to adjust the gap, a gap adjustment device is first provided. In addition, however, it can also happen during operation that foreign substances that are too hard and cannot be crushed get into the material to be crushed. There is then a risk that the crushing gap will become clogged or even that the roll fitted with crushing jaws and the rocker fitted with crushing jaws will be damaged. It is therefore known to equip eccentric roll crushers with an overload safety device which is arranged between the rocker and an abutment which is stationary with the housing frame. The preload force of the springs is selected in such a way that they do not flex under normal breaking loads. If, on the other hand, there is a risk of the crushing jaws being overloaded, the rocker can move back against the force of the springs and thus widen the crushing chamber in order to be able to eject foreign bodies if necessary. However, it has proven to be disadvantageous that very large, stable springs have to be used for support, which springs do not flex under normal breaking stress. Furthermore, the transition region is also only difficult to adjust due to the typical spring characteristics. There is also the disadvantage that very large spring forces continue to act during the springing back, so that damage cannot be ruled out. Finally, when springs are used, there can also be an undefined transitional region in which the springs are only partially compressed, wherein an undefined operating state then results which, for example, can lead to an incorrect particle size of the crushed material to be crushed over a longer period of time.

The present invention is not limited to an embodiment of the roll crusher as an eccentric roll crusher. Thus, U.S. Pat. No. 1,141,643 and DE 1 077 037 show generic roll crushers with a roll that is driven directly in rotation. This roll interacts with a rocker which is held by a spring-loaded overload safety device.

An eccentric roll crusher from the Applicant here is disclosed, for example, in WO 2014/067882 A2. It is proposed there to adjust the rocker via an adjustment device which has a wedge which can be moved back and forth between a first position and a second position. The wedge itself is driven and moved mechanically or hydraulically. An overload safety device can also be provided, which can take place via a bypass valve or a pressure relief valve in the case of hydraulic actuation of the wedge, and by a mechanical predetermined breaking point in the case of mechanical actuation of the wedge, for example via an adjusting spindle. The counter bearing for the wedge on the machine rack side can be rotated about an axis in order to be able to compensate for the rotation of the rocker when the rocker is adjusted.

This type of adjustment has proven itself because, on the one hand, due to the wedge, a transmission between the drive force for the wedge and the deflection of the rocker is achieved such that no excessive forces act on the drive device for the wedge. In the event of an overload, for example because the material to be crushed in the crushing chamber is too large or the material is too hard, the wedge can still be displaced by the rocker and the overload safety device triggered. If the overload safety device is triggered, the rocker can open further and the material that cannot be crushed can be transported out of the crushing chamber.

Further eccentric roll crushers are disclosed in WO 2014/067858 A1, WO 2014/067867 A1, WO 2019/134864 A1 and DE 10 2019 204 836 B3 .

The object of the present invention is to further improve a roll crusher of the type mentioned at the outset, in particular with regard to damage caused by overload.

The invention solves the problem in a roll crusher of the type mentioned according to the invention by the features of claim 1. In particular, it is provided that the roller is loosely mounted on the machine frame and that the roller crusher has a roller adjustment device for adjusting the roller perpendicular to its axis of rotation in the direction of the rocker for setting the crushing gap.

Thus, the roller crusher of the present invention turns away from the path taken by the prior art of the stationary rotating roll and movable rocker, in that the roll itself is loosely mounted and is thus mounted on the machine frame so that it can be displaced with respect to its axis of rotation. The roll can be either a directly driven roll or an eccentric roll, which rotates in a stationary manner, but the roll body itself is provided with an eccentricity. The roll can be adjusted substantially horizontally or diagonally, in particular on a curved track. The roll adjustment device is preferably designed in such a way that there is at least a minimal crushing gap, but this can be widened in particular for the removal of material to be crushed that is too large or foreign bodies. The widening of the crushing gap can take place purely passively, due to reaction forces when the material to be crushed is too large or foreign bodies in the crushing chamber, or actively by means of an actuator provided for this purpose.

In a preferred development, the roll crusher has a rocker adjustment device which is arranged at a distance from the rocker axle between the rocker and a rocker abutment which is stationary with the machine frame, in order to enable the rocker to rotate about the rocker axle. It is preferably provided here that the rocker adjustment device has a rocker wedge arranged between the rocker and the rocker abutment, which bridges a gap between a contact surface arranged on a rear side of the rocker and a counter surface assigned to the rocker abutment, wherein in a second position of the rocker wedge in the gap, the crushing gap is larger than in a first position, wherein the rocker abutment is formed by an axis of rotation on which a rocker counter element with the counter surface depicted thereon is freely rotatable. This configuration is substantially based on the disclosure WO 2014/067882 A2, the content of which is fully incorporated herein by reference. The rocker adjustment device is preferably formed according to one or more features of the adjustment device according to WO 2014/067882 A2. A floating bearing unit can be provided, wherein the roll is accommodated in the floating bearing unit, and wherein the roll adjustment device acts on the floating bearing unit in order to adjust the roll. The floating bearing unit can be mounted as a structural unit on the machine rack, in particular in a sliding manner. Alternatively, the floating bearing unit can also consist of two separate first and second bearings, wherein a respective shaft journal, which extends axially on the roll on opposite sides, is accommodated in the first and second floating bearings. A slide bearing is preferably provided between the floating bearing unit or the floating bearings of the floating bearing unit and the machine rack in order to enable the roll to be displaced and thus adjusted. This slide bearing can be oil-lubricated to allow smooth movement.

In one embodiment, the roll adjustment device comprises at least one first roll wedge, which bridges a gap between a contact surface arranged on the rear side of the bearing and a counter surface assigned to a roll abutment, wherein the crushing gap is larger in a second position of the roll wedge in the gap than in a first position. In the event that the floating bearing unit comprises two separate floating bearings for the shaft ends of the roll, two roll wedges can also be provided, wherein a first roll wedge can be assigned to a first floating bearing and a second roll wedge can be assigned to a second floating bearing of the floating bearing unit. The at least first roll wedge can be designed similarly or identically to the rocker wedge and is preferably not realized to be self-locking. The roll abutment is preferably formed by an axis of rotation on which a roll counter element with a counter surface formed thereon is freely rotatable. In this way, certain displacements of the roll can be compensated.

In a preferred development, the roll crusher has a synchronization device for the roll, which is executed to limit misalignment to a predetermined level. This is particularly preferred when the floating bearing unit comprises two separate floating bearings for the two shaft ends of the roll. To a certain extent, the synchronization device allows the first and second floating bearings to be displaced independently, which can then cause the roll to run misaligned, i.e. twisting the roll perpendicularly to the axis of rotation and perpendicularly to the direction of the adjustment device. Some misalignment in a certain frame may be preferable, especially when a high load occurs only on one side of the roll. By allowing a certain degree of misalignment, the roll can also deviate slightly on one side and thus prevent overloading. A synchronization device that can be used advantageously within the scope of the invention and can limit the misalignment to a predetermined level is known in WO 2021/023643 A1 of the present Applicant, the disclosure content of which is fully incorporated herein by reference. In particular, the synchronization device of the present invention can comprise one or all features of the synchronization device from WO 2021/023643.

In a preferred development, it is provided that the roll adjustment device has at least one first spring, wherein the crushing gap is able to be widened against the force of the first spring. A second spring is preferably provided, wherein the first spring is assigned to the first floating bearing and the second spring is assigned to the second floating bearing. The first and second springs are preferably executed in such a way that they do not flex under normal loading and only flex under a force that can lead to an overload, thus widening the crushing gap. In order to completely prevent misalignment, a mechanical coupling of the first and second springs can be provided, for example via a linearly guided plate.

Additionally or alternatively, the roll adjustment device can have at least one first hydraulic or pneumatic piston for adjusting the crushing gap. While the spring only allows passive adjustment due to the reaction force, the crushing gap can be actively adjusted to a specific, desired size using a hydraulic or pneumatic piston. In this way, not only can wear be compensated, but a target particle size of the roll crusher can also be adjusted. It should be understood that a roll adjustment device that has a first hydraulic or pneumatic piston can also have a first spring. In this context, the spring can then function as an overload safety device, while the first hydraulic or pneumatic piston is used to set a nominal size of the crushing gap.

It is also preferred that the roll adjustment device has at least one first spindle drive for adjusting the crushing gap. The first spindle drive can also be used as an alternative or in addition to the hydraulic or pneumatic piston and/or alternatively in addition to the spring. A nominal crushing gap can also be set using a spindle drive.

Furthermore, it is preferred that the roll adjustment device, if it has a roller wedge, has at least one roll counterweight, wherein the crushing gap is expandable against the weight of the roll counterweight. The roll wedge is preferably executed in such a way that it is not self-locking. The roll counterweight can act on the crushing gap, for example via a deflection roll, and pull and hold the roll wedge in a position that corresponds to a specific crushing gap. Due to the non-self-locking of the roll wedge, the roll can then give way against a crushing force and move the wedge, as a result of which the roll counterweight is lifted. In this way, an alternative realization of the spring can be achieved, which does not result in an increasing force with increasing deflection, as is the case with springs due to the spring constant.

In order to further prevent overloading, the roll adjustment device can have at least one roll overload protection. This is preferably selected in accordance with the corresponding actuator or passive elements. An overload protection can include, for example, a predetermined breaking point, a mechanical spring, a bypass valve, a pressure relief valve, a counterweight. In certain embodiments, for example, the roll counterweight described above can act as overload protection while a nominal crushing gap is set by means of a hydraulic piston. Provision can also be made for a nominal crushing gap to be set by a spindle drive, while overload protection is provided via a pressure relief valve of a pneumatic piston. It should be understood that all conceivable combinations and variants are included herein.

The rocker adjustment device can also be driven in different ways. Examples include: Spring, hydraulic piston, pneumatic piston, spindle drive, rocker counterweight, which can preferably be designed in accordance with the roll counterweight described above.

In a second aspect, the invention solves the problem with a method of the type mentioned at the beginning with the features of claim 14. It is to be understood that the roll crusher according to the first aspect of the invention, the method according to the second aspect of the invention have like and similar sub-aspects as particularly laid down in the dependent claims. In this respect, reference is also made in full to the above description of the first aspect of the invention for preferred developments of the method according to the second aspect of the invention. The method according to the second aspect of the invention preferably comprises the steps: Conveying material to be crushed to the roll crusher; screening of material to be crushed below a predetermined particle size; feeding material to be crushed above the predetermined particle size to the crushing chamber, and adjusting the roll to widen the crushing gap in the event that material to be crushed of an unsuitable particle size and/or made of an unsuitable material enters the crushing chamber. According to the method, it can also be provided that the rocker is also or alternatively adjusted to widen the crushing gap in the event that material to be crushed of an unsuitable particle size and/or made of an unsuitable material enters the crushing chamber.

Alternatively or in addition to the step of adjusting the roll and/or rocker to widen the crushing gap, one or more of the following steps can also be carried out. A crushing gap is preferably initially set by adjusting the rocker and/or roll. A fixed specified nominal crushing gap can be set here, with which the size of the resulting crushed material is then specified. In this case, the roll and/or rocker should be stationary during operation and only be actively or passively deflected in the event of an impending overload. It is also conceivable and preferred that a specific pressure is set in the crushing gap by adjusting the rocker and/or roll. In this case, a gap is thus not set and, if necessary, regulated, but a pressure between the roll and the rocker, which is used to crush the material. If the pressure increases due to large material in the crushing chamber, in this variant the roll and/or rocker are adjusted or give way until the pressure is balanced again. Such a control can be particularly easy in variants with hydraulic, pneumatic or force-based adjustment of roll and/or rocker. Furthermore, an adjustment can also be considered if a larger resulting product is desired during the crushing process. It is also preferred to adjust the roll and/or rocker to compensate for wear, particularly on the crushing jaws.

The invention thus offers a possibility not only to adjust the rocker, as is known in the prior art, but also to adjust the roll. If there is unsuitable material in the crushing chamber or for maintenance purposes, either the roll can be displaced or the rocker can be displaced, or both the roll and the rocker can be displaced. If both the roll and the rocker are displaced, the crushing chamber is widened to the maximum, which can also simplify maintenance.

In a further aspect, a roll crusher is disclosed which only has a rocker adjustment device according to one of the embodiments disclosed herein, but no roll adjustment device. Further, it should be understood that any of the rocker adjustment device embodiments disclosed herein may be combined with any of the roll adjustment device embodiments disclosed herein. Any of the rocker adjustment devices disclosed herein may be used with or without a rocker overload protection, and any roll adjustment device disclosed herein may be realized with or without a roll overload protection. It is also conceivable and preferred that a rocker adjustment device and a roll overload protection or a roll adjustment device and a rocker overload protection are used. Such embodiments are also part of the disclosure.

Embodiments of the invention will now be described below with reference to the drawings. These are not necessarily intended to represent the embodiments to scale, rather, where helpful in explanation, the drawings are presented in schematic and/or slightly distorted form. With regard to additions to the teachings that can be seen directly from the drawings, reference is made to the relevant state of the art. In this context, it must be taken into account that a wide variety of modifications and changes relating to the form and detail of an embodiment can be made without deviating from the general idea of the invention. The features of the invention disclosed in the description, in the drawings and in the claims can be substantial for the further development of the invention both individually and in any combination. In addition, all combinations of at least two of the features disclosed in the description, the drawings and/or the claims fall within the scope of the invention. The general idea of the invention is not limited to the exact form or detail of the preferred embodiments shown and described below, or limited to a subject matter which would be limited compared to the subject matter claimed in the claims. In the case of specified design ranges, values lying within the specified limits should also be disclosed as limit values and be usable and stressable as required. For the sake of simplicity, the same reference numerals are used below for identical or similar parts or parts with an identical or similar function.

Further advantages, features and details of the invention result from the following description of the preferred embodiments and from the drawings; these show in:

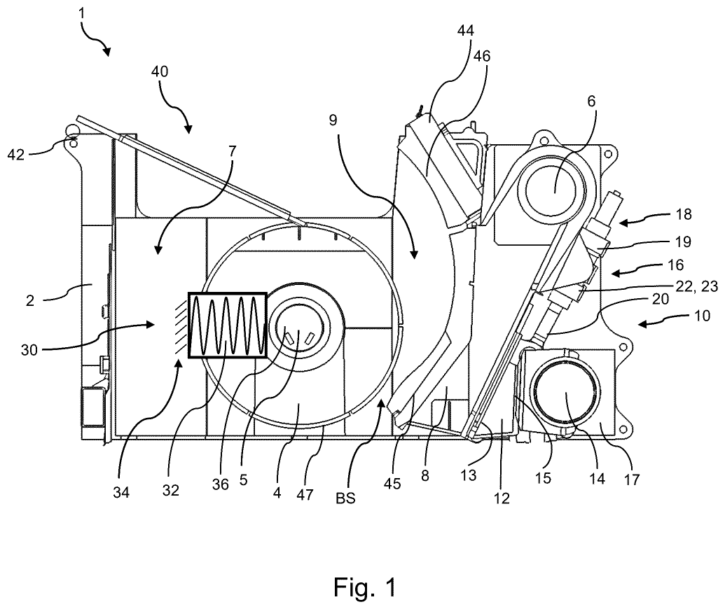

FIG. 1 a schematic longitudinal section of a roll crusher in a first exemplary embodiment;

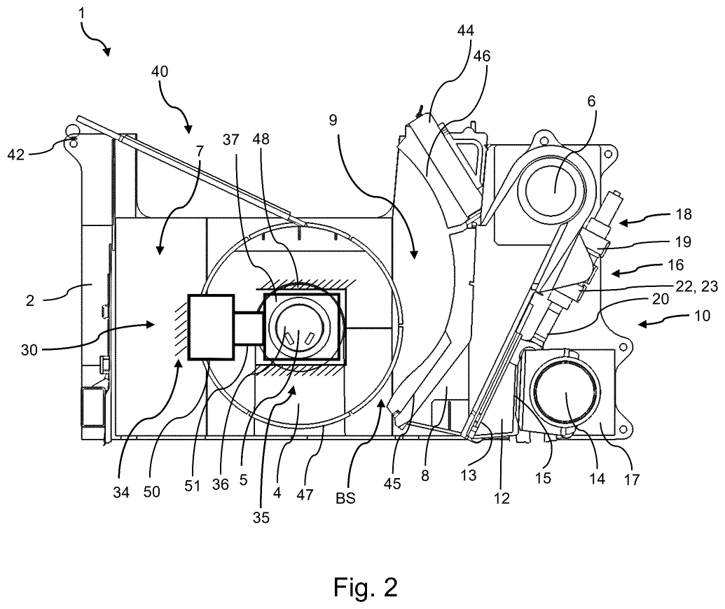

FIG. 2 a schematic longitudinal section of a roll crusher in a second exemplary embodiment;

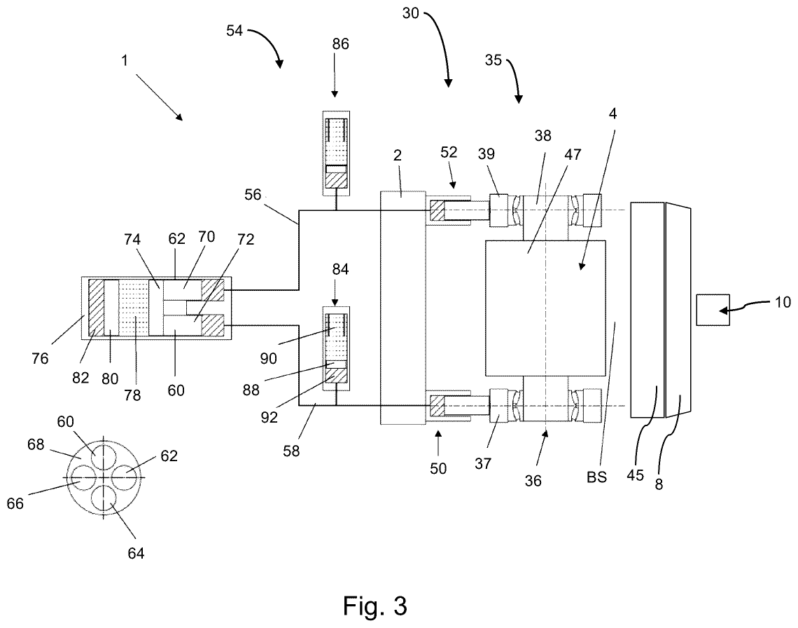

FIG. 3 a schematic cross-section of the roll crusher according to FIG. 2;

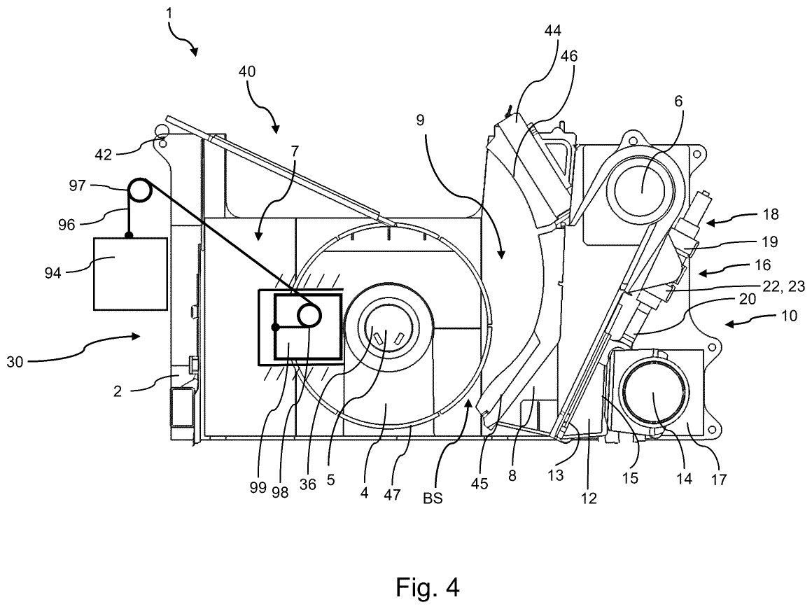

FIG. 4 a schematic longitudinal section of a roll crusher in a third exemplary embodiment;

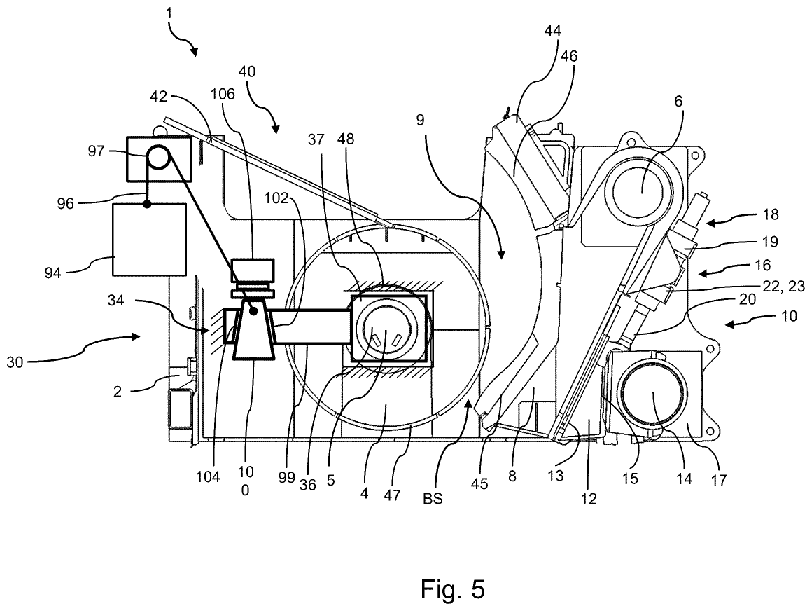

FIG. 5 a schematic longitudinal section of a roll crusher in a fourth exemplary embodiment;

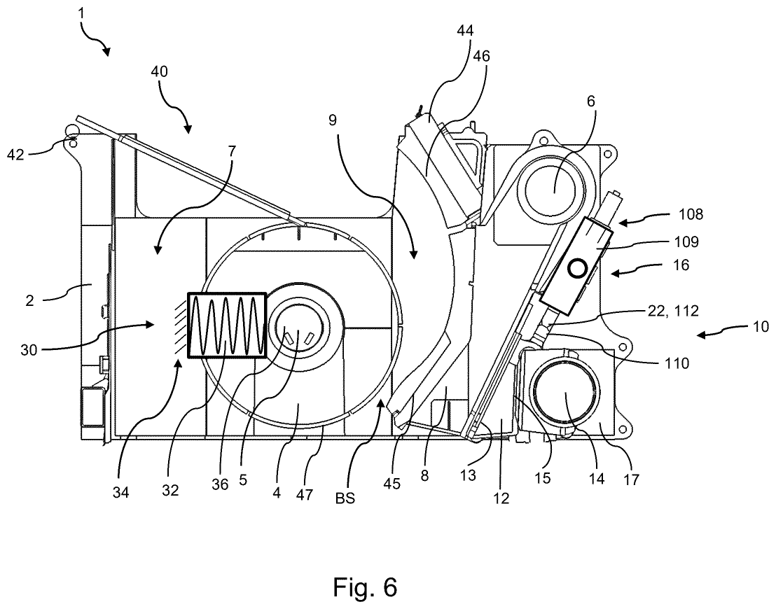

FIG. 6 a schematic longitudinal section of a roll crusher in a fifth exemplary embodiment;

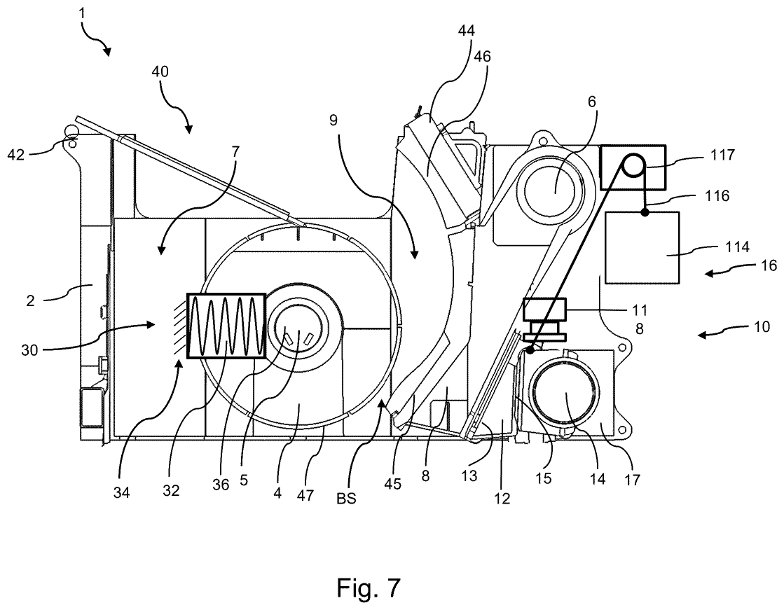

FIG. 7 a schematic longitudinal section of a roll crusher in a sixth exemplary embodiment;

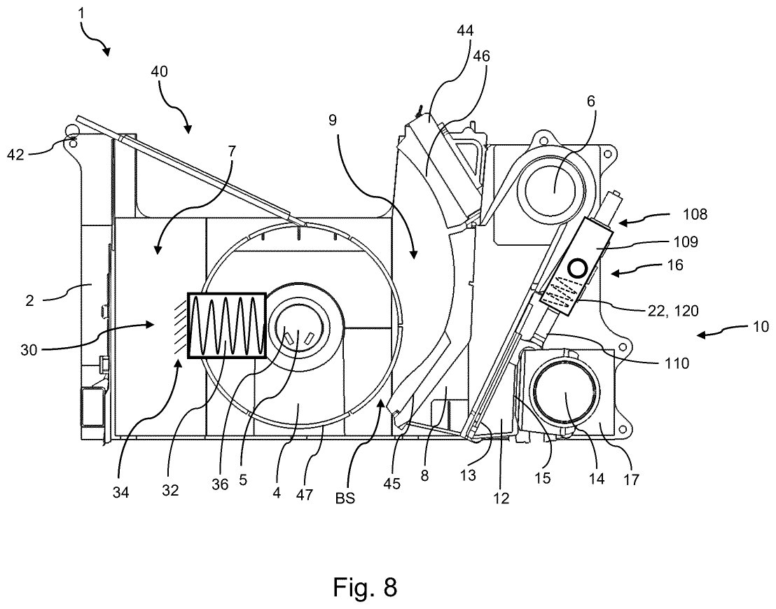

FIG. 8 a schematic longitudinal section of a roll crusher in a seventh exemplary embodiment.

A roll crusher 1, which is configured here by way of example as an eccentric roll crusher, comprises a machine frame 2, a rotatable roll 4, a rocker 8 mounted on a rocker axle 6 on the machine frame 2, a crushing chamber 9 between roll 4 and rocker 8 and a screen chamber 7. A crushing gap BS is formed at the lower end of the crushing chamber 9 between the rocker 8 and the roll 4 and defines the smallest distance between the roll 4 and the rocker 8. During operation, the roll 4 rotates about an axis of rotation 5, wherein the roll 4 is designed here with an eccentricity, so that the roll body 4 rotates eccentrically about the axis of rotation 5. When the roll 4 rotates eccentrically, the distance between the roll 4 and the rocker 8 changes, so that material to be crushed that is placed in the crushing chamber 9 can be comminuted.

The rocker 8 is provided here with a rocker adjustment device 10, which can be designed as known from WO 2014/067882 A2. Specifically, the rocker adjustment device 10 comprises a rocker wedge 12 which is arranged in a gap between a contact surface 13 formed on the rear side of the rocker and a counter surface 15 assigned to a rocker abutment 14. The rocker wedge 12 can be positioned within the gap with a rocker wedge drive 16 of the rocker adjustment device 10 in order to change the distance between rocker 8 and roll 4 and thus the effective crushing gap BS. When the rocker wedge 12 is moved downwardly with respect to FIG. 1 towards its second position, the distance between roll 4 and rocker 8 increases. On the other hand, when the rocker wedge 12 is moved upwards towards its first position P1, the crushing gap BS between roll 4 and rocker 8 decreases.

The rocker wedge 12, the contact surface 13 and the counter surface 15 are aligned with one another in such a way that the rocker wedge 12 is pushed downwards by the forces acting on the rocker 8, i.e. in the direction of the second position P2. The geometry of the contact surface 13, the counter surface 15 and the rocker wedge 12 is selected so that the rocker wedge 12 is not self-locking, i.e. no self-locking occurs. In particular, the rocker wedge 12 can be set up to automatically move downwards in the direction of the second position after being decoupled from the rocker wedge drive 16. The counter surface 15 is formed on a counter holder 17, which forms a fixed bearing but is arranged so as to be rotatable about the abutment 14, which is designed as an axle journal. In this way, the counter surface 15 can rotate about the abutment 14 when the rocker wedge 12 is adjusted. This takes into account the fact that the rocker 8 rotates about the rocker axle 6 when the rocker wedge 12 is adjusted.

In the embodiment shown here (FIG. 1), the rocker wedge drive 16 comprises a hydraulic or pneumatic drive 18, with a hydraulic or pneumatic cylinder 19, which is here firmly connected to the rocker 8, and a hydraulic or pneumatic piston 20, which is connected in an articulated manner to the rocker wedge. By appropriate application of hydraulic or pneumatic pressure inside the hydraulic or pneumatic cylinder 19, the hydraulic or pneumatic piston 20 can be moved up or down with respect to FIG. 1 in order to adjust the rocker wedge.

The rocker adjustment device 10 also comprises a rocker overload protection 22, which comprises a pressure relief valve 23 here, such that hydraulic or pneumatic fluid can be released from the pressure relief valve 23 when the rocker 8 is overloaded, in order to bring the rocker wedge 12 to a lower position and thus widen the crushing gap BS.

In addition to the rocker adjustment device 10, the embodiment shown here (FIG. 1) of the roll crusher 1 comprises a roll adjustment device 30. The roll adjustment device 30 is used to adjust the roll 4 perpendicular to its axis of rotation 5 in the direction of the rocker 8 for setting the crushing gap BS. In order to allow a deflection of the roll 4 with reference to FIG. 1 in the horizontal direction, it is loosely mounted. In the exemplary embodiment shown in FIG. 1, the roll adjustment device 30 is designed to be purely passive and comprises at least one first spring 32. The compression spring 32 is supported against a support 34 which is connected to the machine frame 2. The first spring 32 can act directly on a first shaft shoulder 36 of the roll 4, or (as will be described in detail later with reference to FIGS. 2 and 3) on a first bearing housing of the first shaft shoulder 36. The spring 32 is preferably dimensioned such that it does not flex during normal operation but only deflects if a force in the crushing chamber 9 would exceed a load limit of the roll crusher 1 and there is thus a risk of damage to the roll crusher 1. For this purpose, the spring 32 can be prestressed. In addition or as an alternative, a second spring (not shown) can also be provided on the other side of the roll 4 (not shown in FIG. 1), on the second shaft shoulder (not shown in FIG. 1). It can also be provided that only a first spring is provided, which then acts on both the first and the second shaft shoulder via a holding mechanism. Provision can also be made for the first and the second spring to be coupled to one another, so that a synchronization of the roll 4 is ensured. The support 34 can also be attached to the machine frame 2 in an articulated manner, so that no moments are introduced into the machine frame 2.

FIG. 1 also shows that a screening device 40 is provided above the roll 4, which is supported on the one hand on a stationary abutment 42 on the machine frame 2 and on the other hand on a support surface of the roll 4. A movement of the roll 4 causes a shaking movement on the support surface between screening device 40 and roll 4. The screening device 40 can also rotate about the abutment 42 so that the screening device 40 can compensate for an eccentric rotation of the roll 4. The screening device 40 is designed in such a way that material to be crushed below a predetermined size falls through the screen and can be guided past the roll 4 to the left with reference to FIG. 1, i.e. does not get into the crushing chamber 9. Only material to be crushed with a size above the predetermined size, i.e. material to be crushed that cannot pass through the screening device 40, is fed to the crushing chamber 9. The screening device 40 is preferably designed in accordance with WO 2014/067867 and can have one or all of the features of the screening device described there. In particular, it can be provided that the screening device 2 comprises a finger screen and/or sliding shoes are provided and/or elastic damping elements and/or rubber buffers.

The roll crusher 1 also has a guide element 44 that is separate from the rocker 8 and is attached to the machine frame 2. The guide element 44 is separate from the rocker 8 and stationary and does not move together with the rocker 8, neither when the crushing gap is adjusted nor during any overload compensation movement of the rocker 8. The guide element 44 is preferably formed in accordance with WO 2014/067858 A1 and has one or all features of the guide element according to WO 2014/067858 A1 .

Both the rocker 8 and the guide element 44 and the roll 4 are equipped with crushing jaws 45, 46, 47. The crushing jaws 45, 46, 47 are wearing parts that can be replaced. The crushing jaws 45, 46 on the rocker 8 and the guide element 44 are designed profiled, the crushing jaw 45 on the rocker 8, particularly in the lower region of the crushing gap, is wavy or has a convex-concave shape. The crushing jaws 47 of the roll 4 are arranged in a circle around the roll 4.

FIG. 2 now shows a second exemplary embodiment of the roll crusher 1. Identical and similar elements are provided with the same reference numerals, so that full reference is made to the above description of the first exemplary embodiment (FIG. 1). In the following, the differences from the first exemplary embodiment are highlighted in particular.

The substantial difference in the second exemplary embodiment (FIG. 2) from the first exemplary embodiment (FIG. 1) is that the roll adjustment device 30 is designed differently. First of all, a floating bearing unit 35 is provided for the roll 4, which here on the first shaft shoulder 36 comprises a first bearing housing 37 which is mounted in a first bearing guide 48 on the machine frame 2. The first bearing guide 48 can, for example, comprise a lateral guide for the first bearing housing 37, which is formed, for example, in the shape of a groove or dovetail guide. The first bearing guide 48 can be lubricated with oil and is designed in particular as a slide bearing. With reference to FIG. 2 to the right, i.e. in the direction of the rocker 8, the first bearing guide 48 preferably comprises a stop so that displacement of the roll 4 in the direction of the rocker 8 is limited so that a contact between the rocker 8 and roll 4 is prevented.

Another difference from the first exemplary embodiment is that instead of the spring 32, a hydraulic actuator 50 is now provided. The hydraulic actuator 50 is supported on the one hand on the support 34 and on the other hand acts against the first bearing housing 37 in order to move it towards the rocker 8 and to load it. It is preferably provided that a piston 51 of the hydraulic actuator 50 does not have to absorb any moments, but is connected to the first bearing housing 37 in a moment-free manner, for example via a spherical cap. The hydraulic actuator 50 can have overload protection in the form of a pressure relief valve or bypass valve. In particular, it can be provided in the embodiment shown in FIG. 2 that only one overload protection, either the overload protection 22 or the overload protection on the roll adjustment device 30 is provided. Preferably, however, both the rocker adjustment device 10 and the roll adjustment device 30 have their own overload protection. In this way, the safety of the roll crusher 1 can be further improved.

FIG. 3 shows a schematic cross-section through the roll crusher 1 according to FIG. 2 perpendicular to the view in FIG. 2. FIG. 3 shows the roll crusher 1 with the roll 4 and opposite the rocker 8. The crushing gap BS is formed between the roll 4 and the rocker 8. The roll 4 has first and second shaft shoulders 36, 38 extending at opposite axial ends of the roll. As basically described with reference to FIG. 2, the first shaft shoulder 36 is rotatably accommodated in a first bearing housing 37 by means of a ball bearing. The second shaft shoulder 38 is rotatably accommodated in a second bearing housing 39 by means of a ball bearing.

As shown in FIG. 2, the first hydraulic actuator 50 acts on the first bearing housing 37, and a second hydraulic actuator 52 is provided on the second bearing housing 39 here. The hydraulic actuators 50, 52 each serve to apply a crushing force in the direction of the rocker 8 to the roll 4, which is mounted in the floating bearing unit 35. The hydraulic actuators 50, 52 are each supported with their one end on the first and second bearing housings 37, 39 and with their opposite end on the machine frame 2. A movement of the respective bearing housing 37, 39 of the floating bearing unit 35 results in a corresponding movement of the hydraulic actuator 50, 52 attached to it. Each hydraulic actuator 50, 52 preferably has a cylinder and a piston movably attached thereto, wherein the movement of the hydraulic actuator is understood to mean, for example, a movement of the piston within the cylinder.

In the embodiment shown here, the roll crusher 1 also has a synchronization device 54 which is connected to the hydraulic actuators 50, 52 via hydraulic lines 56, 58. The synchronization device 54 serves to couple, in particular to synchronize, the movement of the hydraulic actuators 50, 52, so that the bearing housings 37, 39 move in a coupled manner or move in the same way and, in particular, misalignment of the roll 4 is avoided or preferably limited. The synchronization device 54 is preferably designed in such a way that a movement of one of the hydraulic actuators 50, 52 results in a corresponding movement of the other of the hydraulic actuators 50, 52.

The synchronization device 54 has a plurality of hydraulic cylinders 60, 62, 64, 66. The detailed view at the bottom left in FIG. 3 shows four hydraulic cylinders 60, 62, 64, 66, which are arranged in a housing 68, for example. It is also conceivable and preferred to provide only two hydraulic cylinders, six, eight or, for example, ten hydraulic cylinders. In each case half of the hydraulic cylinders 60-66 is preferably exclusively connected to one of the hydraulic actuators 50, 52. For example, one, two or more hydraulic actuators 50, 52 are attached to each bearing housing 37, 39 of the floating bearing unit 35, wherein half of the hydraulic cylinders 60-66 of the synchronization device 54 are preferably hydraulically connected exclusively to the hydraulic actuators 50, 52 of a respective bearing housing 37, 39. For example, each hydraulic cylinder 60-66 of the synchronization device 54 is connected to exactly one hydraulic actuator 50, 52.

A piston 70, 72 protrudes from each of the hydraulic cylinders 60-66 with one end each protruding from the respective hydraulic cylinder 60-66, wherein the end of the piston 70, 72 protruding from the hydraulic cylinder is attached to a mechanical coupling 74. The mechanical coupling 74 is, for example, a plate to which the pistons 70, 72 are attached. The pistons 70, 72 are preferably aligned parallel to one another and orthogonal to the mechanical coupling 62, preferably the plate. Hydraulic cylinders 60-66 are connected to hydraulic actuators 50, 52 via hydraulic lines 56, 58. The roll crusher preferably has two hydraulic lines 56, 58, wherein one hydraulic line 56 is connected to the hydraulic actuators 52 of a bearing housing 39 of the floating bearing unit 35 and the other hydraulic line 58 is connected to the hydraulic actuators 50 of the other bearing housing 37 of the floating bearing unit 35. Each of the hydraulic lines 56, 58 is preferably connected exclusively to one half of the hydraulic cylinders 60-66 of the synchronization device 54.

By way of example, the mechanical coupling 74 in the exemplary embodiment in FIG. 3 is designed as a piston, wherein the synchronization device 54 has a cylinder 76 with a gas chamber 78 which is preferably filled with a compressible gas such as nitrogen. The gas chamber 78 is delimited, for example, by the mechanical coupling 74, which also acts as a piston here, and an additional piston 80, wherein the additional piston 80 separates the gas chamber 78 from a hydraulic chamber 82. The hydraulic chamber 82 is preferably filled with an incompressible hydraulic oil and in particular is connected to a hydraulic pump (not shown) via a hydraulic line.

In the exemplary embodiment of FIG. 3, a buffer unit 84, 86 is arranged between the synchronization device 54 and each hydraulic actuator 50, 52. The buffer units 84, 86 are each connected to the synchronization device 54 and the hydraulic actuators 50, 52 via one of the hydraulic lines 56, 58. The buffer units 84, 86 are preferably of substantially identical design. Each buffer unit 84, 86 is designed in particular as a single-acting hydraulic cylinder and each has a cylinder with a piston 88 which separates a gas chamber 90 from a hydraulic chamber 92 and is movable within the cylinder. The gas chamber 90 is preferably filled with a compressible gas such as nitrogen, wherein the hydraulic chamber 92 is filled with an incompressible hydraulic oil and connected to the respective hydraulic line 56, 58 so that hydraulic oil can flow from the respective hydraulic line 56, 58 into the hydraulic chamber 92. The buffer units 84, 86 serve as buffers between the synchronization device 54 and the hydraulic actuators 50, 52, so that the hydraulic actuators 50, 52 are at least partially decoupled from the synchronization device 54 when the movement of the hydraulic actuators 50, 52 does not exceed a certain path limit value. The path limit value is preferably a deviation in the position of the hydraulic actuator 50, 52 relative to a zero position, which corresponds to the desired size of the crushing gap BS. In this way, a limited misalignment can be made possible and, in particular, unilateral forces acting on the roll on one side can be compensated for. In this respect, the buffer units 84, 86 also act as roll overload protection and allow the roll 4 to partially deviate. The gas chamber 78 also serves as overload protection and allows the roll 4 to deviate altogether via the synchronization device 54.

As an alternative to the first and second hydraulic actuators 50, 52, a direct mechanical coupling can also be provided for the first and second bearing housings 37, 39, which then only interacts with a single or a plurality of hydraulic actuators, and in this respect always causes a coupling of the first and second bearing housings 37, 39. Also, it should be understood that the buffer units 84, 86 are only optional.

If actuators for adjusting the roll 4 are considered below, it should be understood that these can always act either on the bearing housing 37, 39, as described with reference to FIG. 3, for example, or in a common mechanism connecting the bearing housings 37, 39, such as, for example, its own bearing housing, which uniformly accommodates the first and second shaft shoulders 36, 38.

Otherwise, instead of the synchronization device 54, as described in FIG. 3, a synchronization device as described in WO 2021/023643 can also be implemented, in particular alternative embodiments of both the synchronization device and the buffer units described there.

The exemplary embodiment of the roll crusher 1 shown in FIG. 4 is in turn based on the exemplary embodiment of the roll crusher 1 shown in FIGS. 1 and 2, wherein identical and similar elements are in turn provided with the same reference numerals. In this respect, reference is made in full to the above description of FIGS. 1 and 2.

A significant difference to the first and second exemplary embodiment (FIG. 1, 2, 3) lies in the design of the roll adjustment device 30. This is designed purely mechanically here and comprises a roll counterweight 94 which acts, via a traction cable 96, which via a first deflection 97 on the machine frame 2 and a second deflection 98, also acts on the machine frame 2 on a support element 99, which in turn loads the roll 4 in the direction of the rocker 8. The support element 99 is slidably mounted in a guide on the machine frame 2 and can either interact directly with the roll 4 or a shaft shoulder 36, 38 or, as described with reference to FIG. 3, with the first or second bearing housing 37, 39. Again, a separate roll counterweight 94 can be provided for the first and the second shaft shoulder 36, 38, or a roll counterweight 94 is provided for the roll 4 as a whole. If two separate roll counterweights are provided, a synchronization device can also be realized by coupling these counterweights.

In this way, in turn, a passive roll adjustment device 30 is realized, which can also function as overload protection. The roll counterweight 94 can, for example, be selected in such a way that it is only raised by deflecting the roll 4 when an overload is imminent.

A fourth exemplary embodiment shown in FIG. 5 is substantially based on the third exemplary embodiment shown in FIG. 4, and the same and similar elements are again provided with the same reference numerals. In this respect, reference is made in full to the above description of FIG. 4. The roll adjustment device 30 according to the fourth exemplary embodiment (FIG. 5) again uses the roll counterweight 94, which, however, in the embodiment shown here does not act on the support element 99, but on a roll wedge 100. The roll wedge 100 bridges a gap between a contact surface 102 arranged on a rear side of the bearing and a counter surface 104 assigned to a roll abutment 34, wherein the crushing gap is larger in a second position P2 of the roll wedge 100 in the gap than in a first position P1. With reference to FIG. 5, the second position P2 is a lower position, while the position P1 is an upper position. In the exemplary embodiment shown in FIG. 5, the contact surface 102 is not arranged directly on the bearing housing 37, but on a support element 99. The support element 99 can be connected to the bearing housing 37 in one piece or in some other way, or the contact surface 102 is arranged directly on the bearing housing. Furthermore, both the contact surface 102 and the counter surface 104 are arranged at an angle, which is not absolutely necessary. In particular, it can be provided that only the contact surface 102 or the counter surface 104 is arranged at an angle. Furthermore, a stop 106 is provided, which can be adjusted by means of one or more spacers and which prevents the roll wedge 100 from moving out in the vertical direction. In this way, a displacement of the roll 4 in the direction of the rocker 8 can be limited. This dimension can be limited by inserting certain spacers.

The other exemplary embodiments shown in FIGS. 6 to 8 are initially substantially based on the exemplary embodiment shown in FIG. 1, wherein the rocker adjustment device 10 is designed differently in each case. Again, the same and similar elements are provided with the same reference numerals and reference is made in full to the above description.

In the fifth exemplary embodiment (FIG. 6), the rocker wedge drive 16 comprises, instead of a hydraulic or pneumatic drive 18, a mechanical drive, for example a spindle drive 108, with a nut 109 which is rotatably arranged within a nut housing and rotates about an axially movable but non-rotating spindle 110. The spindle 110, like the hydraulic or pneumatic piston 20 (FIG. 1), is pivotally connected to the rocker wedge 12 and can drive it. A predetermined breaking point 112 is provided here as a rocker overload protection 22, which is formed on the spindle 110 and breaks above a certain tensile load, so that the rocker 8 can open.

It should be understood that the rocker adjustment device 10 according to the fifth embodiment (FIG. 6) can also be combined with any of the roll adjustment devices 30 according to the exemplary embodiments 1, 2, 3 and 4. Furthermore, the rocker adjustment device 10 according to the fifth exemplary embodiment can be used both with and without overload protection. The same also applies to all roll adjustment devices disclosed herein, each of which is preferred and possible with and without overload protection.

In a sixth exemplary embodiment, the roll crusher 1 is again based on the first exemplary embodiment according to FIG. 1, and the same and similar elements are provided with the same reference numerals. In this respect, reference is made in full to the above description. In turn, the sixth exemplary embodiment (FIG. 7) again differs in the rocker adjustment device 10, which here comprises a rocker wedge drive 16 that uses a rocker counterweight 114 and thus uses the same principle that has already been described with reference to FIGS. 4 and 5. The rocker counterweight 114 is connected to a cable 116, which is guided over a first rocker-side deflection roll 117 and is connected at the other end to the rocker wedge 12, so that the weight of the rocker counterweight 114 loads the rocker wedge 12 in the first, upper position. As already described with reference to FIG. 5, a stop 118 is also provided in the exemplary embodiment according to FIG. 7, which limits movement of the rocker wedge 12 in the vertical direction. The effect of the stop 118 can also be adjusted, in particular by using one or more washers, spacers or the like.

Again, it applies here that the rocker adjustment device 10 according to the sixth exemplary embodiment can be combined with all roll adjustment devices 30 of the previous exemplary embodiments. The combination with the roll adjustment devices 30 according to FIGS. 4 and 5 is particularly advantageous. A seventh exemplary embodiment (FIG. 8) is based on the fifth exemplary embodiment (FIG. 6) and the same and similar elements are again provided with the same reference numerals. In contrast to the fifth exemplary embodiment according to FIG. 6, no predetermined breaking point 112 is provided as overload protection 22 in the seventh exemplary embodiment according to FIG. 8, but rather a spring 120. This has the advantage that when the overload protection 22 is triggered, the spindle 110 does not have to be replaced, but only the spring 120 is deflected.

### LIST OF REFERENCE NUMERALS (PART OF THE DESCRIPTION)

1 roll crusher
2 machine frame
4 roll
6 rocker axle
7 screening chamber
8 rocker
9 crushing chamber
10 rocker adjustment device
12 rocker wedge
13 contact surface on rear side of rocker
14 abutment
15 counter surface
16 rocker wedge drive
17 rocker counter element
18 hydraulic or pneumatic drive
19 hydraulic or pneumatic cylinder
20 hydraulic or pneumatic piston
22 rocker overload protection
23 pressure relief valve
30 rocker adjustment device
32 first spring
34 support
35 floating bearing unit
36 first shaft shoulder
37 first bearing housing
38 first shaft shoulder
39 second bearing housing
40 screening device
42 stationary abutment
44 guide element
45, 46, 47 crushing jaws
48 first bearing guide
50 first hydraulic actuator
51 piston
52 second hydraulic actuator
54 synchronization device
56 hydraulic line
58 hydraulic line
60, 62, 64, 66 hydraulic cylinder
68 housing
70, 72 piston
74 mechanical coupling
76 cylinder
78 gas chamber
80 additional piston
82 hydraulic chamber
84 first buffer unit
86 second buffer unit
88 piston or buffer unit
90 gas chamber of the buffer unit
92 hydraulic chamber of the buffer unit
94 roll counterweight
96 traction cable
97 first deflection roll
98 second deflection roll
99 support element
100 roll wedge
102 contact surface
104 counter surface
106 stop
108 spindle drive
109 nut
110 spindle
112 predetermined breaking point
114 rocker counterweight
116 cable
117 deflection roll
118 stop
120 spring
BS crushing gap
P1 first position
P2 second position

1. Roll crusher (1) with a machine frame (2), with a rotatable roll (4), with a rocker (8) mounted on a rocker axle (6) on the machine frame (2), with a crushing chamber (9) between roll (4) and rocker (8), wherein an adjustable crushing gap (BS) between roll (4) and rocker (8) is formed at a lower end of the crushing chamber,
wherein the roller (4) is loosely mounted on the machine frame (2), and
with a roll adjustment device (30) for adjusting the roll (4) perpendicular to its axis of rotation (5) in the direction of the rocker (8) for adjusting the crushing gap (BS).

2. Roll crusher according to claim 1, having a rocker adjustment device (10) which is arranged at a distance from the rocker axle (6) between the rocker (8) and a rocker abutment (14) which is stationary with the machine frame (2), in order to enable the rocker (8) to rotate about the rocker axle (6).

3. Roll crusher according to claim 2, wherein the rocker adjustment device (10) has a rocker wedge (12) arranged between the rocker (8) and the rocker abutment (14), which bridges a gap between a contact surface (13) arranged on a rear side of the rocker and a counter surface (15) assigned to the rocker abutment (14), wherein in a second position (P2) of the rocker wedge (12) in the gap, the crushing gap (BS) is larger than in a first position (P1), wherein the rocker abutment (14) is formed by an axis of rotation on which a rocker counter element (17) with the counter surface (15) depicted thereon is freely rotatable.

4. Roll crusher according to any one of the preceding claims, having a floating bearing unit, wherein the roll (4) is accommodated in the floating bearing unit (35), and wherein the roll adjustment device (30) acts on the floating bearing unit (35) in order to adjust the roll (4).

5. Roll crusher according to any one of the preceding claims, wherein the roll adjustment device (30) has at least one first roll wedge (100), which bridges a gap between a contact surface (102) arranged on a rear side of the bearing and a counter surface (104) assigned to a roll abutment (34), wherein in a second position (P2) of the roll wedge (100) in the gap, the crushing gap (BS) is larger than in a first position (P1).

6. Roll crusher according to any one of the preceding claims, having a synchronization device (54) for the roll (4), which is executed to limit misalignment to a predetermined level.

7. Roll crusher according to any one of the preceding claims, wherein the roll adjustment device (30) has at least one first spring (32), wherein the crushing gap (BS) is able to be widened against the force of the first spring (32).

8. Roll crusher according to any one of the preceding claims, wherein the roll adjustment device (30) has at least one first hydraulic or pneumatic actuator (50, 52) for adjusting the crushing gap (BS).

9. Roll crusher according to any one of the preceding claims, wherein the roll adjustment device (30) has at least one first spindle drive for adjusting the crushing gap.

10. Roll crusher according to any one of the preceding claims, wherein the roll adjustment device (30) has at least one roll counterweight (94), wherein the crushing gap (BS) is able to be widened against the weight of the roll counterweight (94).

11. Roll crusher according to any one of the preceding claims, wherein the roll adjustment device (30) has at least one roll overload protection.

12. Roll crusher according to claim 11, wherein the roll overload protection comprises at least one of the following: predetermined breaking point, mechanical spring, bypass valve, pressure relief valve, counterweight.

13. Roll crusher according to claim 2 or 3, wherein the rocker adjustment device (10) comprises at least one of the following: spring (120), hydraulic piston (18), pneumatic piston, spindle drive (108), rocker counterweight (114).

14. Method for operating a roll crusher (1), preferably according to any one of the preceding claims, comprising the steps:
conveying material to be crushed to the roll crusher (1);
screening of material to be crushed below a predetermined particle size;
supplying material to be crushed above the predetermined particle size to the crushing chamber (9);
adjusting the roll (4) to widen the crushing gap (BS) in the event that material to be crushed of an unsuitable particle size and/or from an unsuitable material enters the crushing chamber (9).

15. Method according to claim 14, comprising the step of:
adjusting the rocker (8) to widen the crushing gap (BS) in the event that material to be crushed of an unsuitable particle size and/or from an unsuitable material enters the crushing chamber (9).
